(19) United States
(12) Patent Application Publication
(10) Pub. No.: US 2026/0161826 A1
(43) Pub. Date: Jun. 11, 2026

(54) SECURITY CONTROL FOR A TARGET APPLICATION

(71) Applicants: Lemon Inc., Grand Cayman (KY); Beijing Zitiao Network Technology Co., Ltd., Beijing (CN)

(72) Inventors: Heqing HUANG, Los Angeles, CA (US); Kai GUO, Beijing (CN)

(21) Appl. No.: 18/977,610

(22) Filed: Dec. 11, 2024

(51) Int. Cl. G06F 21/64

(52) U.S. Cl. CPC G06F 21/64

(57) ABSTRACT

Embodiments of the present disclosure provide a solution for security control for a target application. A method includes: verifying first information in a workflow based on a first tag of the first information and a security level of a first processing node in the workflow, the workflow comprising at least one processing node and configured to perform a task in the target application; in accordance with a determination that verification of the first information is successful, processing the first information by the first processing node; and in accordance with a determination that the verification is not successful, performing a security processing operation.

### FIELD

The present disclosure generally relates to computer technologies, and more specifically, to a method, apparatus, device and computer readable storage medium for security control for a target application.

### BACKGROUND

A machine learning model is a type of algorithm that allows a computer system to learn from data without being explicitly programmed. Essentially, the machine learning model identifies patterns and relationships within data sets, allowing it to make informed decisions or predictions about new, unseen data. Language models (LMs) are foundational in the field of content generation and have given rise to a variety of applications. LM-based applications may be used for text generation, chatbots and virtual assistants, question answering and the like. In the context of LM-based applications, especially those with retrieval-augmented generation (RAG)-style applications that incorporate external data and logic flows through plugins, the data and logic flow pose challenges to security control and monitoring of these applications.

### SUMMARY

In a first aspect of the present disclosure, there is provided a method of security control for a target application. The method comprises: verifying first information in a workflow based on a first tag of the first information and a security level of a first processing node in the workflow, the workflow comprising at least one processing node and configured to perform a task in the target application; in accordance with a determination that verification of the first information is successful, processing the first information by the first processing node; and in accordance with a determination that the verification is not successful, performing a security processing operation.

In a second aspect of the present disclosure, there is provided an apparatus for security control for a target application. The apparatus comprises: a first information verifying module configured to verify first information in a workflow based on a first tag of the first information and a security level of a first processing node in the workflow, the workflow comprising at least one processing node and configured to perform a task in the target application; a first information processing module configured to, in accordance with a determination that verification of the first information is successful, process the first information by the first processing node; and a security processing operation performing module configured to, in accordance with a determination that the verification is not successful, perform a security processing operation.

In a third aspect of the present disclosure, there is provided an electronic device. The electronic device comprises: at least one processing unit; and at least one memory coupled to the at least one processing unit and storing instructions executable by the at least one processing unit, the instructions, upon execution by the at least one processing unit, causing the electronic device to perform: verifying first information in a workflow based on a first tag of the first information and a security level of a first processing node in the workflow, the workflow comprising at least one processing node and configured to perform a task in the target application; in accordance with a determination that verification of the first information is successful, processing the first information by the first processing node; and in accordance with a determination that the verification is not successful, performing a security processing operation.

In a fourth aspect of the present disclosure, a computer-readable storage medium is provided. The computer-readable storage medium stores computer executable instructions which, when executed by an electronic device, causes the electronic device perform operations comprising: verifying first information in a workflow based on a first tag of the first information and a security level of a first processing node in the workflow, the workflow comprising at least one processing node and configured to perform a task in the target application; in accordance with a determination that verification of the first information is successful, processing the first information by the first processing node; and in accordance with a determination that the verification is not successful, performing a security processing operation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2 illustrates a flowchart of a process of security control for a target application in accordance with some embodiments of the present disclosure;

FIG. 3 illustrates a schematic diagram of an example process of security control for a target application using a language model in accordance with some embodiments of the present disclosure;

FIG. 4 shows a block diagram of an apparatus for security control for a target application in accordance with some embodiments of the present disclosure; and

FIG. 5 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

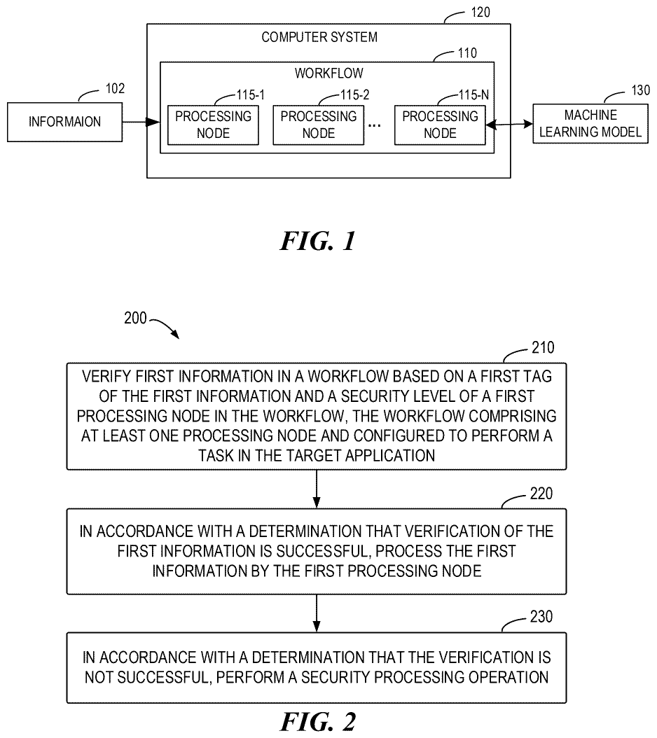

FIG. 1 illustrates a block diagram of an example environment 100 in which various embodiments of the present disclosure may be implemented. In the environment 100, a computer system 120 may perform a workflow 110 to implement a functionality or provide a service to a user. For example, the workflow 110 may be used to process a user input and generate a response to the user input.

The workflow 110 includes a plurality of processing nodes 115-1 to 115-N and each of the processing nodes 115-1 to 115-N may be configured to process input information and generate an output. For ease of illustration, the plurality of processing nodes 115-1 to 115-N may be referred to as “processing nodes 115” collectively or a “processing node 115” individually. In operation, information 102 may be provided to the workflow 110 for processing. The information 102 may be input to the workflow 110 at any of the processing nodes 115-1 to 115-N. It is to be noted that although the plurality of processing nodes is shown sequentially, this is merely illustrative without any limitation. The plurality of processing node may be arranged in any suitable pattern, including a sequential pattern, a parallel pattern, or a combination thereof. The protection scope of the present disclosure is not limited in this regard.

In some embodiments, the workflow 110 may be configured to use a machine learning model 130 to perform a task such as text generation, image generation, text-to-speech generation and the like. For example, at least one processing node of the workflow 110 may be configured to use the machine learning model. It is noted that although a singular form is used for the machine learning mode, more than one machine learning model may be used in the workflow 110. The machine learning model 130 may include any type of models based on machine learning. In an example, the machine learning model 130 may include an LM, such as a large language model (LLM). In another example, the machine learning model 130 may include a multi-modal model, which has the capability of NLP.

In some embodiments, the workflow 110 may be implemented in an application, which may be referred to as a model based application, for example, an LM-based application. Such an application may include more than one workflow.

In the environment 100, the computer system 120 may include any computing system with computing capability, such as various computing devices/systems, terminal devices, servers, etc. Terminal devices may include any type of mobile terminals, fixed terminals, or portable terminals, including mobile phones, desktop computers, laptops, netbooks, tablets, media computers, multimedia tablets, or any0 combination of the aforementioned, including accessories and peripherals of these devices or any combination 0thereof. Servers include but are not limited to mainframe, edge computing nodes, computing devices in cloud environment, etc. The machine learning model 130 may be implemented, for example, in various types of computing systems/servers capable of providing computing power, including but not limited to mainframe, edge computing nodes, computing devices in cloud environments, and the like.

It should be understood that the structure and function of each element in the environment 100 is described for illustrative purposes only and does not imply any limitations on the scope of the present disclosure.

As briefly mentioned above, there are security challenges in utilization of a machine learning model, for example, in LM-based applications. Taking the LM-based applications as an example, some frameworks in LM-based applications offer various features for different use cases. For example, these frameworks enable the integration of LMs with external data sources and logic flows, which is especially important in the case of RAG-style applications. RAG-style applications augment the capabilities of language models by incorporating potential external data and workflows using plugins. However, this flexibility also brings challenges.

The data and logic flow in LM-based applications are complex. With the integration of external data and logic flows, it becomes difficult to ensure security control and monitoring. Current security mechanisms lack the ability to provide fine-grained security for the various types of elements involved in the application, such as data, code, and a combination of data and code.

Traditional security control models have not been effectively adapted to the unique environment of LM-based applications. There is a need to bridge the gap between the security requirements of these applications and the existing security models.

Embodiments of the present disclosure propose an improved solution of security control for a target application. In this solution, first information in a workflow is verified based on a first tag of the first information and a security level of a first processing node in the workflow. The workflow comprises at least one processing node and is configured to perform a task in the target application. In accordance with a determination that verification of the first information is successful, the first information is processed by the first processing node. In accordance with a determination that the verification is not successful, a security processing operation is performed.

With these embodiments of the present disclosure, tags representing trust levels of different information may be propagated along the workflow. In this way, a more detailed and precise security assessment along the information flow the workflow is enabled. In addition, the security level of the workflow may be enhanced and the integrity of the workflow may be guaranteed.

Example embodiments of the present disclosure will be described with reference to the drawings.

FIG. 2 illustrates a flowchart of a process 200 of security control for a target application in accordance with some embodiments of the present disclosure. The process 200 may be implemented at the computer system 120 of FIG. 1. The process 200 is described with reference to FIG. 1 as an example.

Before starting the process 200, a pre-requisite is described. In some embodiments, a processing node 115 in the workflow 110 may have a security level, which indicates a security requirement on information inputted to the processing node 115. For example, a configuration file for the workflow 110 may be provided to the computer system 120. The configuration file may include respective configurations of the plurality of processing nodes 115. The configuration file may be provided by a user or a manager of the workflow 110. A configuration of the processing node 115 may include the security level of the processing node 115. In some embodiments, each of the plurality of processing node 115 may be configured with a security level. Alternatively, in some embodiments, a portion of the plurality of processing nodes 115 may be configured with a security level. For example, the one or more processing nodes using a machine learning model is configured with a security level.

At block 210, the computer system 120 verifies first information (as an example of the information 102) in a workflow 110 based on a first tag of the first information and a security level of a first processing node in the workflow 110. The workflow may comprise at least one processing node and configured to perform a task in a target application. The target application provides services based on a machine learning model (e.g., the machine learning model 130). The task may include for example image generation, video generation, question answering, content recommendation, etc. The first processing node may be any of the at least one processing node in the workflow 110. In some examples, the security level of the first processing node may indicate a security requirement on information to be processed by the first processing node.

In some embodiments, the first information may include data to be processed in the first processing node. In some examples, the first information may include a text, and the workflow may generate a speech corresponding to the text by processing the text.

Alternatively, or in addition, the first information may include an instruction to be performed in the first processing node. In some examples, the first information may include an instruction (e.g., an instruction for text generation) in the form of code. Upon receiving the instruction for text generation, the workflow may generate a text about a specific topic.

Alternatively, or in addition, the first information may include a combination of the data and the instruction. In some examples, the combination of the data and the instruction may be considered as part of input data and part of programming logic.

In this way, the trust level of different kinds of information may be considered and thus the output generated based on such information may be more reliable.

In some embodiments, the first processing node is configured to perform content generation by using a machine learning model. The combination of the data and the instruction may include a prompt (such as a system prompt) for the machine learning model. In some examples, the machine learning model may include a language model, such as an LLM. The system prompt may be used to guide the behavior of the language model, such as setting a context, assigning a role, defining a task and the like for the language model.

Some example embodiments regarding how to assign the first tag to the first information are now described. In some embodiments, the first information may be inputted into the workflow 110. In other words, the first information may be external information inputted into the workflow 110 at the first processing node. In an example, the first processing node may be the begging node of the workflow 110, which receives inputs from external source, such as a user input, etc.

In such embodiments, the computer system 120 may assign the first tag to the first information based on one or more sources from which the first information is obtained. The first information may be obtained from a trusted source, an external source with known security risks and the like. In some examples, if the first information is obtained from an official database (as an example of the trusted source) owned by the publisher of the workflow 110, the first tag representing a high trust level may be assigned to the first information. If the first information is obtained from a third-party application programming interface (as an example of the external source), the first tag representing a low or medium trust level may be assigned to the first information.

Alternatively, or in addition, the computer system 120 may assign the first tag to the first information based on one or more characteristics of the first information. The characteristics of the first information may involve a storage environment, an access control method and a transmission method of the first information. In some examples, if the first information is transmitted based on transport layer security (TLS), the first tag representing a high trust level may be assigned to the first information. If the first information is transmitted based on transmission control protocol (TCP), the first tag representing a low or medium trust level may be assigned to the first information. In this way, tags for information may be properly classified based on sources and/or characteristics information and thus the security risks in the information may be identified quickly. Therefore, information with security risks may be avoided to be processed and the security level of the workflow may be improved.

In some embodiments, the first processing node may be configured to perform retrieval-augmented generation (RAG) by using a machine learning model. At least a part of the first information may be obtained by retrieving the one or more sources. For example, reference information may be retrieved from the one or more sources and the reference information may be included in a prompt to be provided to the machine learning model.

In some embodiments, the first information may be obtained from a plurality of sources, for example external sources. The computer system 120 may determine the trust level of the first information based on respective trust levels of the plurality of sources. In some examples, in a case where the first information is formed by a plurality of parts which are obtained from a plurality of sources, the trust level of the first information may be determined by taking into account respective trust levels of the plurality of sources.

In some embodiments, the computer system 120 may determine the trust level of the first information based on at least one of: the lowest trust level of the respective trust levels, or an average trust level of the respective trust levels. In some examples, the respective trust levels may include a low trust level, a medium trust level and a high trust level. The trust level of the first information may be determined as the low trust level (i.e., the lowest trust level of the respective trust levels). Alternatively, the trust level of the first information may be determined as medium trust level (i.e., the average trust level of the respective trust levels).

After the trust level of the first information is determined, the computer system 120 assigns a predetermined tag corresponding to the determined trust level as the first tag. In an example, if the determined trust level is the medium trust level, a predetermined tag corresponding to the medium trust level may be assigned to the first information as the first tag.

Alternatively, in some embodiments, the first information may be output by another processing node in the workflow 110. In other words, the first information may be an intermediate processing result in the workflow 110. In such embodiments, the trust level of the first information may be determined based on the trust level of information for generating the first information. This is similar to the determination of the trust level of the second information (as described below) and thus is not repeated here.

In some embodiments, if a trust level of the first information represented by the first tag is higher than or equal to the security level of the first processing node, the computer system 120 may determine that the verification of the first information is successful. The first tag may represent the trust level of the first information, such as low level, medium level, high level and the like. In a case where the trust level (e.g., high level or medium level) of the first information is higher than or equal to the security level (medium level) of the first processing node, the verification of the first information may be determined as successful. In this way, information with different trust levels is handled appropriately and thus unauthorized access and modification to the processing node may be prevented.

At block 220, if verification of the first information is successful, the computer system 120 processes the first information by the first processing node. If the verification of the first information is successful (e.g., the trust level of the first information is higher than or equal to the security level of the first processing node), the first information may be processed by the first processing node. In some examples, the first processing node may be configured to perform a text-to-speech task, and the first processing node may convert a text (as an example of the first information) to a speech (as an example of the second information).

In some embodiments, the first processing node may be configured to perform content generation by using a machine learning model. In order to process the first information by the first processing node, prompt information may be generated based on the first information. Then, the prompt information may be provided to the machine learning model to obtain an output of the machine learning model.

In some embodiments, the first information may be processed by the first processing node to obtain second information. Then, the computer system 120 may assign, to the second information, a second tag representing a trust level of the second information based on the first tag. In this way, tags representing trust levels of information are propagated in the workflow. In some examples, the trust level of the second information represented by the second tag may be the same as the trust level of the first information represented by the first tag. Alternatively, the trust level of the second information may be different from the trust level of the first information. In some embodiments, the trust level represented by the second tag does not exceed the trust level represented by the first tag. In this way, data security can be ensured by propagating the tag along the workflow.

In some embodiments, the input to the first processing node may include not only the first information but also additional information, which is also referred to as third information. The third information may be assigned with a third tag representing a trust level of the third information. The third information may include information from an external source and/or information outputted by another processing node in the workflow 110. In other words, the second information may be obtained from processing of the first information and the third information by the first processing node.

In such embodiments, the trust level of the second information may be determined based on both the trust level of the first information and the trust level of the third information. The computer system 120 may assign the second tag based on a lower trust level of a trust level represented by the first tag and a trust level represented by the third tag. In some examples, in addition to the first information, the third information is also processed by the first processing node to obtain the second information. If the first tag indicates a high trust level and the third tag indicates a medium trust level, the second tag representing a medium trust level (i.e., the lower trust level of the trust level represented by the first tag and the trust level represented by the third tag) may be assigned to the second information.

After the second tag is assigned, the second information may be processed by a second processing node succeeding the first processing node based on the second tag of the second information and a security level of the second processing node. If the trust level indicated by the second information is higher than or equal to the security level of the second processing node, the second information may be processed by the second processing node. Otherwise, the second information may not be processed by the second processing node and failed result for the workflow may be generated. Then, a processing result for the workflow 110 may be determined based on the processing of the second information. For example, the processing result may include information obtained by processing the second information or the failed result.

At block 230, if the verification is not successful, the computer system 120 may perform a security processing operation. The security processing operation may be different for different processing nodes in the workflow. The security processing operation may be predefined or indicated in the configuration file for the workflow. The security processing operation may include for example data interception, adding a special label, or issuing an alert. In some examples, the computer system 220 may intercept the first information. Alternatively, or in addition, the computer system 220 may not intercept the first information but add special markings. Alternatively, or in addition, the computer system 220 may process the first information normally but issue an alert.

In some embodiments, if the verification is not successful, the computer system 220 may prevent the first information to be processed by the first processing node and generate a failed result for the workflow 110. If the verification is not successful (e.g., the trust level of the first information is lower than the security level of the first processing node), the first information may not be processed by the first processing node. With these embodiments, the at least one machine learning model may be protected from executing malicious code or performing on unsecured data. In this way, the accuracy and reliability of the output of the workflow may be enhanced.

After the second tag is assigned, at block 240, the computer system 120 obtains a processing result of the workflow based on the second information and the second tag. In some examples, the second information may be processed based on whether the trust level indicated by the second tag satisfies a security requirement of the workflow 110.

In embodiments of the present disclosure, information is assigned with a tag representing its trust level as the information is inputted into the workflow. Subsequent information which is derived from the information may be assigned with a tag for trust level representation. In other words, the tag is propagated to the subsequent information. Through propagation of the tags, the security level of the workflow may be enhanced and the integrity of the workflow may be guaranteed.

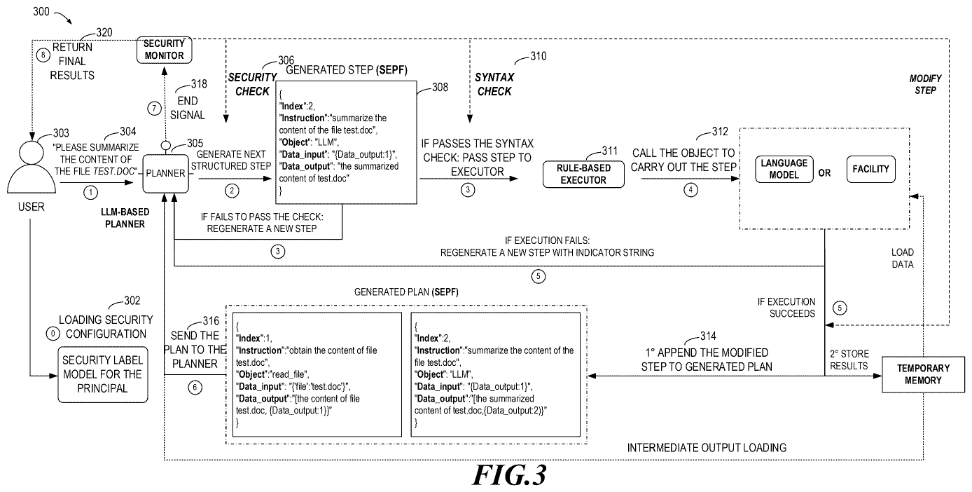

An example process 200 is described above. To better understand the solution, a specific example is now described with reference to FIG. 3. FIG. 3 illustrates a schematic diagram of an example process 300 of security control for an application using LM in accordance with some embodiments of the present disclosure. As shown in FIG. 3, at 302, a user 303 may upload a security configuration to the computer system. The security configuration may specify the rule of assigning tags to different information based on a source or a characteristic of the information. At 304, the user may send a user input (as an example of the first information) to a planner 305. In an example, the user input may ask the planner 305 to summarize the content of a document.

At 306, a security check may be performed to verify the summarizing instruction. For example, if the trust level of the summarizing instruction is higher than or equal to a security level of a processing node configured to summarize the content, the summarizing operation may be performed. At 308, the security check is passed, an execution plan is generated. At 310, a syntax check is performed on the execution plan. If the syntax check is passed, a rule-based executor 311 may filter security risks in the information input in the planner 305.

At 312, the rule-based executor 311 may call the LM or some other tools to perform the summarizing operation. At 314, an updated execution plan (as an example of the second information) may be generated. A tag representing a trust level of the updated execution plan may be assigned to the updated execution plan. At 316, the updated execution plan may be input to the planner 305. At 318, if the trust level of the updated execution plan is lower than the security level of a processing node configured to summarize the content, an end signal may be transmitted, and the summarizing operation may be prevented. At 320, a failed result mat be sent to the user 303. It is to be noted that although security check (also referred to as verification of information input to the workflow) only appear once in the process 300 in FIG. 3, the security check may happen at any step of the process 300.

In some embodiments, the solution for security control for a target application proposed by embodiments of the present disclosure may be applied to a framework used for developing LM-based applications. The framework is used to connect different language models and external data sources, and the proposed solution may monitor the data flowing between different components of the framework. In this way, the data used in different parts of an application supported by the framework may adhere to the appropriate security levels. When the framework is used for tasks such as text generation or question answering, the proposed solution can prevent the use of untrusted data or code (e.g., instruction) in the generation process, thereby enhancing the security and reliability of the output.

In some embodiments, the proposed solution may be applied to a framework used for managing and retrieving data for LM. The proposed solution may be used to protect the integrity of the index-based data retrieval process and ensure that the retrieved data has the appropriate trust level. In addition, the proposed solution may monitor the combination of the data and the instruction (e.g., a system prompt) which is used to query the index. In this way, malicious or incorrect combination of the data and the instruction may be prevented from affecting the retrieval process.

In some embodiments, data with different trust levels (as indicated by the tags) is restricted in its access based on the principle of “no read-up” (i.e., a subject cannot read objects with a security level higher than its security level). For example, a lower-trust data element should not be able to access or influence higher security level data or operations. This is achieved by the propagation of tags. When an operation attempts to access data or code, the computer system 120 checks the tags and enforces the appropriate access restrictions. In this way, confidentiality may be enforced.

In some embodiments, tags are used to determine whether an operation can modify a particular entity. For example, a combination of data and instruction with a lower trust level tag may not be able to modify a information with a higher trust level tag. In this way, the modification of data or code may be prevented by less-trusted entities and integrity may be enhanced.

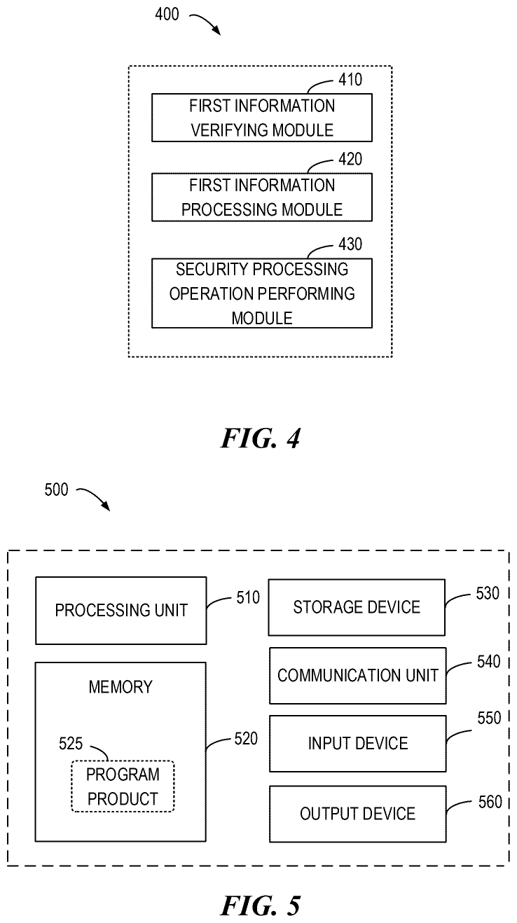

FIG. 4 shows a block diagram of an apparatus 400 for security control for a target application in accordance with some embodiments of the present disclosure. The apparatus 400 may be implemented, for example, or included at the computer system 120 of FIG. 1. Various modules/components in the apparatus 400 may be implemented by hardware, software, firmware, or any combination thereof.

As illustrated, the apparatus 400 includes a first information verifying module 410 configured to verify first information in a workflow based on a first tag of the first information and a security level of a first processing node in the workflow, the workflow comprising at least one processing node and configured to perform a task in the target application.

The apparatus 400 includes a first information processing module 420 configured to, in accordance with a determination that verification of the first information is successful, process the first information by the first processing node.

The apparatus 400 includes a security processing operation performing module 430 configured to, in accordance with a determination that the verification is not successful, perform a security processing operation.

In some embodiments, the first information verifying module 410 is further configured to, in accordance with a determination that a trust level of the first information represented by the first tag is higher than or equal to the security level of the first processing node, determine that the verification of the first information is successful.

In some embodiments, the first information is processed by the first processing node to obtain second information. The apparatus 400 further includes a processing result obtaining module configured to assign, to the second information, a second tag representing a trust level of the second information based on the first tag; process, by a second processing node succeeding the first processing node, the second information based on the second tag of the second information and a security level of the second processing node; and obtain a processing result for the workflow based on the processing of the second information.

In some embodiments, the first information is inputted into the workflow and the apparatus 400 further includes a first tag assigning module configured to assign the first tag to the first information based on at least one of: one or more sources from which the first information is obtained, or one or more characteristics of the first information.

In some embodiments, the first information is obtained from a plurality of sources and the first tag assigning module is further configured to determine the trust level of the first information based on respective trust levels of the plurality of sources and assign, as the first tag, a predetermined tag corresponding to the determined trust level.

In some embodiments, the first tag assigning module is further configured to determine the trust level of the first information based on at least one of: a lowest trust level of the respective trust levels, or an average trust level of the respective trust levels.

In some embodiments, the first processing node is configured to perform retrieval-augmented generation (RAG) by using a machine learning model, and at least a part of the first information is obtained by retrieving the one or more sources.

In some embodiments, the second information is obtained from processing of the first information and third information by the first processing node, the third information is assigned with a third tag. The processing result obtaining module is further configured to assign the second tag based on a lower trust level of a trust level represented by the first tag and a trust level represented by the third tag.

In some embodiments, security processing operation performing module 430 is further configured to prevent the first information to be processed by the first processing node and generate a failed result for the workflow.

In some embodiments, the first processing node is configured to perform content generation by using a machine learning model. The first information processing module 420 is further configured to generate prompt information based on the first information and provide the prompt information to the machine learning model to obtain an output of the machine learning model.

In some embodiments, the first information comprises at least one of: data to be processed in the first processing node, an instruction to be performed in the first processing node, or a combination of the data and the instruction.

In some embodiments, the first processing node is configured to perform content generation by using a machine learning model, and the combination of the data and the instruction comprises a system prompt for the machine learning model.

FIG. 5 illustrates a block diagram of an electronic device 500 in which one or more embodiments of the present disclosure can be implemented. It would be appreciated that the electronic device 500 shown in FIG. 5 is only an example and should not constitute any restriction on the function and scope of the embodiments described herein. The electronic device 500 may be used, for example, to implement the computer system 120 of FIG. 1. The electronic device 500 may also be used to implement the apparatus 400 of FIG. 4.

As shown in FIG. 5, the electronic device 500 is in the form of a general computing device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and can execute various processes according to the programs stored in the memory 520. In a multiprocessor system, multiple processing units execute computer executable instructions in parallel to improve the parallel processing capability of the electronic device 500.

The electronic device 500 typically includes a variety of computer storage medium. Such medium may be any available medium that is accessible to the electronic device 500, including but not limited to volatile and non-volatile medium, removable and non-removable medium. The memory 520 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 530 may be any removable or non-removable medium, and may include a machine-readable medium, such as a flash drive, a disk, or any other medium, which can be used to store information and/or data (such as training data for training) and can be accessed within the electronic device 500.

The electronic device 500 may further include additional removable/non-removable, volatile/non-volatile, transitory/non-transitory storage medium. Although not shown in FIG. 5, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 520 may include a computer program product 525, which has one or more program modules configured to perform various methods or acts of various embodiments of the present disclosure.

The communication unit 540 communicates with a further computing device through the communication medium. In addition, functions of components in the electronic device 500 may be implemented by a single computing cluster or multiple computing machines, which can communicate through a communication connection. Therefore, the electronic device 500 may be operated in a networking environment using a logical connection with one or more other servers, a network personal computer (PC), or another network node.

The input device 550 may be one or more input devices, such as a mouse, a keyboard, a trackball, etc. The output device 560 may be one or more output devices, such as a display, a speaker, a printer, etc. The electronic device 500 may also communicate with one or more external devices (not shown) through the communication unit 540 as required. The external device, such as a storage device, a display device, etc., communicate with one or more devices that enable users to interact with the electronic device 500, or communicate with any device (for example, a network card, a modem, etc.) that makes the electronic device 500 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method of security control for a target application, comprising:
verifying first information in a workflow based on a first tag of the first information and a security level of a first processing node in the workflow, the workflow comprising at least one processing node and configured to perform a task in the target application;
in accordance with a determination that verification of the first information is successful, processing the first information by the first processing node; and
in accordance with a determination that the verification is not successful, performing a security processing operation.

2. The method of claim 1, wherein verifying the first information comprises:
in accordance with a determination that a trust level of the first information represented by the first tag is higher than or equal to the security level of the first processing node, determining that the verification of the first information is successful.

3. The method of claim 1, wherein the first information is processed by the first processing node to obtain second information and the method further comprises:
assigning, to the second information, a second tag representing a trust level of the second information based on the first tag;
processing, by a second processing node succeeding the first processing node, the second information based on the second tag of the second information and a security level of the second processing node; and
obtaining a processing result for the workflow based on the processing of the second information.

4. The method of claim 1, wherein the first information is inputted into the workflow, and the method further comprises:
assigning the first tag to the first information based on at least one of:
one or more sources from which the first information is obtained, or
one or more characteristics of the first information.

5. The method of claim 4, wherein the first information is obtained from a plurality of sources and assigning the first tag to the first information comprises:
determining a trust level of the first information based on respective trust levels of the plurality of sources; and
assigning, as the first tag, a predetermined tag corresponding to the trust level.

6. The method of claim 5, wherein determining the trust level of the first information based on the respective trust levels of the plurality of sources comprises:
determining the trust level of the first information based on at least one of: a lowest trust level of the respective trust levels, or an average trust level of the respective trust levels.

7. The method of claim 4, wherein the first processing node is configured to perform retrieval-augmented generation (RAG) by using a machine learning model, and at least a part of the first information is obtained by retrieving the one or more sources.

8. The method of claim 3, wherein the second information is obtained from processing of the first information and third information by the first processing node, the third information is assigned with a third tag, and assigning the second tag comprises:
assigning the second tag based on a lower trust level of a trust level represented by the first tag and a trust level represented by the third tag.

9. The method of claim 1, wherein performing the security processing operation comprises:
preventing the first information to be processed by the first processing node; and
generating a failed result for the workflow.

10. The method of claim 1, the first processing node is configured to perform content generation by using a machine learning model, and processing the first information by the first processing node comprises:
generating prompt information based on the first information; and
providing the prompt information to the machine learning model to obtain an output of the machine learning model.

11. The method of claim 1, wherein the first information comprises at least one of:
data to be processed in the first processing node,
an instruction to be performed in the first processing node, or
a combination of the data and the instruction.

12. The method of claim 11, wherein the first processing node is configured to perform content generation by using a machine learning model, and the combination of the data and the instruction comprises a system prompt for the machine learning model.

13. An electronic device, comprising:
at least one processing unit; and
at least one memory coupled to the at least one processing unit and storing instructions executable by the at least one processing unit, the instructions, upon execution by the at least one processing unit, causing the electronic device to perform operations comprising:
verifying first information in a workflow based on a first tag of the first information and a security level of a first processing node in the workflow, the workflow comprising at least one processing node and configured to perform a task in a target application;
in accordance with a determination that verification of the first information is successful, processing the first information by the first processing node; and
in accordance with a determination that the verification is not successful, performing a security processing operation.

14. The electronic device of claim 13, wherein verifying the first information comprises:
in accordance with a determination that a trust level of the first information represented by the first tag is higher than or equal to the security level of the first processing node, determining that the verification of the first information is successful.

15. The electronic device of claim 13, wherein the first information is processed by the first processing node to obtain second information and the operations further comprise:
assigning, to the second information, a second tag representing a trust level of the second information based on the first tag;
processing, by a second processing node succeeding the first processing node, the second information based on the second tag of the second information and a security level of the second processing node; and
obtaining a processing result for the workflow based on the processing of the second information.

16. The electronic device of claim 13, wherein the first information is inputted into the workflow, and the operations further comprise:
assigning the first tag to the first information based on at least one of:
one or more sources from which the first information is obtained, or
one or more characteristics of the first information.

17. The electronic device of claim 16, wherein the first information is obtained from a plurality of sources and assigning the first tag to the first information comprises:
determining a trust level of the first information based on respective trust levels of the plurality of sources; and
assigning, as the first tag, a predetermined tag corresponding to the trust level.

18. The electronic device of claim 17, wherein determining the trust level of the first information based on the respective trust levels of the plurality of sources comprises:
determining the trust level of the first information based on at least one of: a lowest trust level of the respective trust levels, or an average trust level of the respective trust levels.

19. The electronic device of claim 16, wherein the first processing node is configured to perform retrieval-augmented generation (RAG) by using a machine learning model, and at least a part of the first information is obtained by retrieving the one or more sources.

20. A non-transitory computer readable storage medium having computer executable instructions stored thereon, the computer executable instructions, when executed by an electronic device, causing the electronic device perform operations comprising:
verifying first information in a workflow based on a first tag of the first information and a security level of a first processing node in the workflow, the workflow comprising at least one processing node and configured to perform a task in a target application;
in accordance with a determination that verification of the first information is successful, processing the first information by the first processing node; and
in accordance with a determination that the verification is not successful, performing a security processing operation.
